(19) United States
(12) Patent Application Publication
(10) Pub. No.: US 2010/0270158 A1
(43) Pub. Date: Oct. 28, 2010

(54) DESALINATION DEVICES AND METHODS

(75) Inventor: Bruce Logan, State College, PA (US)

Correspondence Address: GIFFORD, KRASS, SPRINKLE,ANDERSON & CITKOWSKI, P.C, PO BOX 7021, TROY, MI, 48007-7021, US

(73) Assignee: The Penn State Research Foundation, University Park, PA (US)

(21) Appl. No.: 12/765,192

(22) Filed: Apr. 22, 2010

Related U.S. Application Data
(60) Provisional application No. 61/171,545, filed on Apr. 22, 2009.

(51) Int. Cl. C02F 1/469

(52) U.S. Cl. 204/522; 204/632

(57) ABSTRACT

Microbial processes and systems are provided according to the present invention for desalination of saline materials, such as aqueous mixtures including dissolved salts. Microbial desalination devices according to embodiments of the present invention create hydrogen gas in a configuration referred to as a microbial electrolysis desalination cell (MEDC), or electricity in a configuration referred to as a microbial fuel desalination cell (MFDC) in addition to desalination of saline materials.

### REFERENCED TO RELATED APPLICATION

This application claims priority from U.S. Provisional Patent Application Ser. No. 61/171,545, filed Apr. 22, 2009, the entire content of which is incorporated herein by reference.

### FIELD OF THE INVENTION

The present invention relates generally to methods and devices for desalination of liquids. More specifically, the present invention relates to methods and devices including anodophilic microbes for desalination of liquids.

### BACKGROUND OF THE INVENTION

Separation of the components of salt-containing aqueous solutions has been a goal for centuries. While many technologies have been proposed for this purpose, there is a continuing need for desalination apparatus and methods.

### SUMMARY OF THE INVENTION

Desalination processes according to embodiments of the present invention include generating an electrical potential between an anode and a cathode, wherein at least a portion of the electrical potential is generated by anodophilic bacteria disposed in electrical contact with the anode. A saline material to be desalinated is disposed between the anode and the cathode and the saline material is separated from the anode by an anion exchange material and separated from the cathode by a cation exchange material. Optionally, the anion exchange material and cation exchange material can be in the form of anion and cation exchange membranes, respectively.

Desalination processes according to further embodiments of the present invention include activating a power source in electrical communication with the anode and cathode to increase a potential between the anode and the cathode, such that electrons and protons combine to produce hydrogen and/or methane gas.

Desalination systems are provided according to embodiments of the present invention which include a reaction compartment having a wall defining an interior of the reaction compartment and an exterior of the reaction compartment; an anode at least partially contained within an anode compartment of the reaction compartment; a plurality of anodophilic bacteria disposed in the anode compartment; a cathode at least partially contained within a cathode compartment of the reaction compartment; a conductive conduit for electrons in electrical communication with the anode and the cathode; a saline material compartment disposed between the anode compartment and the cathode compartment; a first anion selective barrier disposed between the saline material and the anode compartment such that anions moving to or towards the anode compartment traverse the first anion selective barrier; and a first cation selective barrier disposed between the saline material and the cathode compartment such that cations moving to or towards the cathode compartment traverse the first cation selective barrier.

In operation, a material oxidizable by an oxidizing activity of the anodophilic bacteria is disposed in the anode compartment. The material is incubated under oxidizing reactions conditions such that electrons are produced by the oxidizing activity of the anodophilic bacteria and transferred to the anode, generating a potential between the anode and cathode. A saline material is introduced into the saline material compartment and ions in the saline material compartment traverse the anion and cation selective barriers, thereby desalinating the saline material.

Optionally, a power source is disposed in electrical communication with the anode and cathode to increase a potential between the anode and the cathode. In a preferred option, a reference electrode is included and the anode potential is set.

More than one anion selective barrier can be included in desalination systems according to embodiments of the present invention. More than one cation selective barrier can be included in desalination systems according to embodiments of the present invention.

In embodiments of the present invention, an included anion selective barrier is an anion exchange membrane. In embodiments of the present invention, an included cation selective barrier is a cation exchange membrane.

Optionally, two or more ion selective barrier pairs are included in a microbial desalination device according to the present invention, each ion selective barrier pair including an anion selective barrier and a cation selective barrier and one or more spacers disposed between the anion selective barrier and the cation selective barrier of each ion selective barrier pair such that each ion selective barrier pair includes a compartment disposed between the anion selective barrier and the cation selective barrier. In embodiments of desalination systems according to the present invention, the anion selective barrier and cation selective barrier included in each ion selective barrier pair are an anion exchange membrane and a cation exchange membrane, respectively.

In a preferred option, the material oxidizable by an oxidizing activity of the anodophilic bacteria is wastewater, such as, but not limited to, animal, human, municipal, agricultural or industrial wastewater. In particular embodiments, the wastewater has a conductivity lower than the conductivity of the saline material. Optionally, saline water is added to the wastewater to increase conductivity of the wastewater prior to introduction of the wastewater into the anode compartment for oxidation by anodophilic bacteria.

Processes according to embodiments of the present invention produce gases, such as hydrogen and methane, which can be used to power a microbial desalination system of the present invention or can be used for other purposes. A system according to embodiments of the present invention optionally includes a gas collection system.

One or more cathodes included in embodiments of microbial desalination systems of the present invention can be air cathodes. Optionally, some or all of the included electrodes can be brush electrodes. In a further option, some or all of the included electrodes can be tubular electrodes.

### BRIEF DESCRIPTION OF THE DRAWING

FIG. 1 is a schematic illustration of embodiments of microbial desalination devices of the present invention;

FIG. 2 is a schematic illustration of embodiments of microbial desalination devices of the present invention;

FIG. 3 is a graph showing performance of an embodiment of a microbial desalination device as a function of initial substrate concentration and NaCl concentration;

FIG. 4A is a graph showing polarization curves obtained using an embodiment of a microbial desalination device of the present invention;

FIG. 4B is a graph showing electrode potentials obtained using an embodiment of a microbial desalination device of the present invention;

FIG. 5A is a graph showing conductivities in compartments of an embodiment of a microbial desalination device;

FIG. 5B is a graph showing comparative performance of different anion exchange materials and cation exchange materials in an embodiment of an inventive microbial desalination device;

FIG. 6A is a graph showing membrane potentials generated by ion concentration gradients across the anion exchange membrane in an embodiment of an inventive microbial desalination device;

FIG. 6B is a graph showing membrane potentials generated by ion concentration gradients across the cation exchange membrane in an embodiment of an inventive microbial desalination device;

FIG. 6C is a graph showing the generated electromotive force in an embodiment of an inventive microbial desalination device;

FIG. 7 is a graph showing volumetric current densities as a function of time in an embodiment of an inventive microbial desalination device; and

FIG. 8 is a graph showing gas production as a function of time in an embodiment of an inventive microbial desalination device.

### DETAILED DESCRIPTION OF THE INVENTION

Microbial desalination devices and methods for their use in desalination of saline materials are provided according to embodiments of the present invention.

The term “saline material” refers to aqueous mixtures including dissolved salts. The term “desalination” as used herein refers to separation of components present in aqueous mixtures, particularly the separation of dissolved mineral salts from aqueous mixtures. For example, desalination refers to separation of halides, carbonates, phosphates and sulfates of sodium, potassium, calcium, lithium, magnesium, zinc or copper from aqueous mixtures. The term desalination encompasses both complete and partial removal of dissolved mineral salts from aqueous mixtures.

Desalination encompasses the production of fresh water from saline materials such as brackish water, saline water, and brine. The term “fresh water” refers to water having less than 0.5 parts per thousand dissolved salts. The term “brackish water” refers to water having 0.5-30 parts per thousand dissolved salts. The term “saline water” refers to water having greater than 30-50 parts per thousand dissolved salts. The term brine refers to water having greater than 50 parts per thousand dissolved salts.

The terms “microbial desalination device” and “microbial desalination cell” are used interchangeably herein to refer to devices of the present invention using anodophilic microbes, particularly anodophilic bacteria, as catalysts to oxidize an organic material oxidizable by an oxidizing activity of the anodophilic microbes and generate electrons. The electrons are transferred to an anode, generating, or adding to, a potential between the anode and a cathode. Ions present in an aqueous fluid are driven by the potential through ion selective material present in the microbial desalination device, separating the ions from the aqueous fluid. Thus, anions move to or towards the anode through an anion exchange membrane (AEM) and cations move through a cation exchange membrane (CEM) to or towards the cathode, separating the ions from the aqueous fluid and thereby desalinating the aqueous fluid.

Microbial desalination devices of the present invention create hydrogen gas in a configuration referred to as a microbial electrolysis desalination cell (MEDC), or electricity in a configuration referred to as a microbial fuel desalination cell (MFDC).

Advantageously, and in contrast to electrodialysis, energy required for desalination in a process according to embodiments of the present invention can be supplied wholly or in part by oxidation of a material that is oxidizable by anodophilic bacteria, so that the overall energy requirement can be much less than that needed for conventional electrodialysis.

Embodiments of systems for desalination according to the present invention include a reaction compartment having a wall defining an interior of the reaction compartment and an exterior of the reaction compartment; an anode at least partially contained within an anode compartment of the reaction compartment; a plurality of anodophilic bacteria disposed in the anode compartment; and a cathode at least partially contained within a cathode compartment of the reaction compartment. A conductive conduit for electrons is in electrical communication. A saline material compartment is disposed between the anode compartment and the cathode compartment. A first anion selective barrier is disposed between the saline material and the anode compartment such that anions moving to or towards the anode traverse the first anion selective barrier. A first cation selective barrier is disposed between the saline material and the cathode compartment such that cations moving to or towards the cathode compartment traverse the first cation selective barrier.

One or more spacers can be included in embodiments of microbial desalination devices of the present invention. One or more seals can be used to inhibit fluid leakage between adjacent compartments.

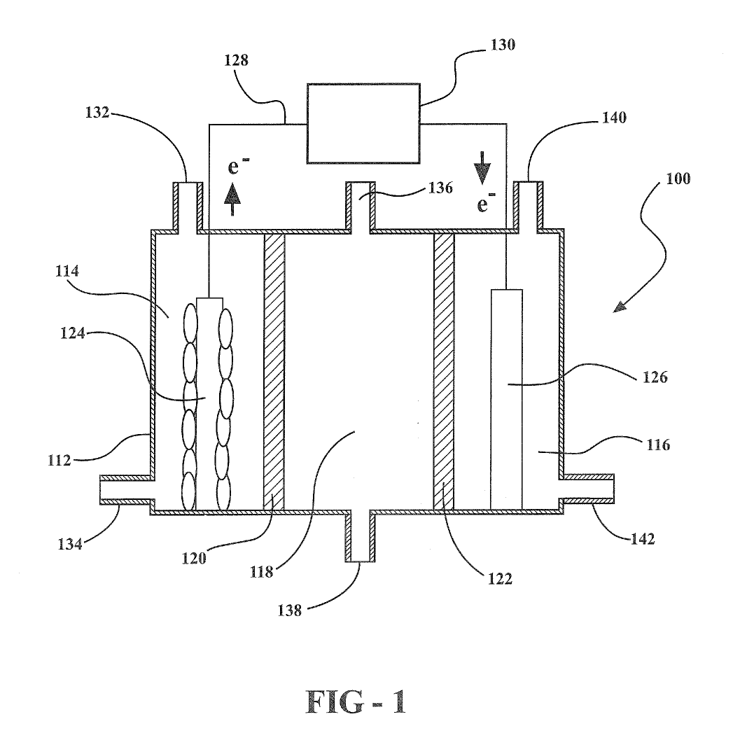

A schematic illustration of embodiments of microbial desalination devices of the present invention is shown in FIG. 1.

FIG. 1 illustrates an embodiment of an inventive system at 100. In this illustration, a reaction chamber is shown having a wall 112 defining the interior and exterior of the reaction chamber. The reaction chamber shown has three compartments, an anode compartment 114, a cathode compartment 116 and a saline material compartment 118 disposed between the anode compartment 114 and cathode compartment 116. An anode exchange membrane 120 is disposed between the anode compartment 114 and the saline material compartment 118. A cathode exchange membrane 122 is disposed between the cathode compartment 116 and the saline material compartment 118. An anode having bacteria disposed thereon is shown at 124 and a cathode is shown at 126. A conduit for electrons 128 is shown along with a connected power source and/or load is shown at 130. One or more channels for inlet and outlet of materials, such as gases, an organic substance oxidizable by the anodophilic bacteria or saline material can be included, examples are shown at 132, 134, 136, 138, 140 and 142.

In operation, anions pass from the saline material compartment 118 through an anion exchange material, here illustrated as an anion exchange membrane 120, to reach the anode compartment 114 containing an anode, 124. Cations pass from the saline material compartment 118 through a cation exchange material, here illustrated as a cation exchange membrane 122, to reach the cathode compartment 116 containing a cathode, 126.

Additional ion selective membranes can be included in a microbial desalination device according to embodiments of the present invention, for example, to trap anions or cations to reduce deposition of scale or other materials on the electrodes.

Multiple compartments can be placed between the electrodes, or multiple compartments and multiple electrodes can be placed in the same device.

In particular embodiments, multiple ion selective barriers are included in a microbial desalination device according to the present invention. In a “stack” configuration, the ion selective barriers are generally parallel with each other and are alternately arranged such that each anion selective barrier is flanked by at least one cation selective barrier. In particular embodiments, two or more ion selective barrier pairs are included in a microbial desalination device according to the present invention, each ion selective barrier pair including an anion selective barrier and a cation selective barrier and one or more spacers disposed between the anion selective barrier and the cation selective barrier of each ion selective barrier pair such that each ion selective barrier pair includes a compartment disposed between the anion selective barrier and the cation selective barrier. One or more seals can be used to inhibit fluid leakage between adjacent compartments. In such configurations, a saline material is introduced into a saline material compartment and ions pass through the corresponding ion selective barrier towards the corresponding electrode to an adjacent compartment, desalinating the saline material in the saline material compartment.

Embodiments of microbial desalination devices according to the present invention include spiral wound ion selective barrier pairs. In a “spiral wound” configuration, a microbial desalination device is generally cylindrical in shape and includes at least one anode, at least one cathode and at least one ion selective barrier pair having a spacer disposed between the anion selective barrier and the cation selective barrier of each ion selective barrier pair. One of the electrodes, the inner electrode, is disposed in an inner position and the at least one ion selective barrier pair is wound radially with respect to the inner electrode. A second electrode, the outer electrode, is disposed in an outer position such that the at least one ion selective barrier pair is between the inner electrode and the outer electrode. Each ion selective barrier pair defines a compartment. One or more seals can be used to inhibit fluid leakage between adjacent compartments.

The volumes of the compartments can be varied to suit the specific needs that vary for the source and product water that depend on the extent of desalination, organic loading and current densities.

Broadly described, both MFDCs and MEDCs include anodophilic microbes, such as anodophilic bacteria, as a catalyst for generation of electrons for production of electricity or hydrogen, respectively. Both MFDCs and MEDCs include an anode, a cathode and an electron conductor connecting the anode and cathode. Anodophilic microbes, such as anodophilic bacteria, capable of oxidizing a substrate to produce electrons are included in both MFDCs and MEDCs.

In operation of an MFDC configuration of a microbial desalination device of the present invention, a provided oxidizable substrate is oxidized by anodophilic microbes, such as anodophilic bacteria which generate electrons and protons. Where the substrate is an organic substrate carbon dioxide is also produced. The electrons are transferred to the anode, and optionally, through a load such as a device to be powered, to the cathode. Protons and electrons react with oxygen at the cathode, producing water. Ions present in an aqueous fluid to be desalinated are driven by the potential through ion selective material present in the microbial desalination device, separating the ions from the aqueous fluid.

In MEDC operation, a provided oxidizable substrate is oxidized by anodophilic microbes, such as anodophilic bacteria, which generate electrons and protons. Where the substrate is an organic substrate carbon dioxide is also produced. A power source is connected to the MEDC and an additional voltage is applied. The electrons generated by the anodophilic microbes, such as anodophilic bacteria, are transferred to the anode, and, through a conductive connector, to the cathode. Oxygen is substantially excluded from the cathode area such that protons and electrons combine at the cathode, producing hydrogen. Ions present in an aqueous fluid to be desalinated are driven by the potential through ion selective material present in the microbial desalination device, separating the ions from the aqueous fluid.

Advantageously, the rate of desalination can be controlled by setting the potentials and current in a microbial desalination device according to embodiments of the present invention. Further, a microbial desalination device configured as an MEDC is operated anaeobically such that aeration of the water is avoided if dissolved oxygen is used at the cathode for reduction. If a chemical catholyte, such as ferricyanide, is used then it would have to be regenerated and desalinated.

Chloride moving from the desalination compartment and being concentrated in the cathode compartment can result in very high Cl concentrations which can have detrimental effects on Pt catalysts in particular cathodes. In a microbial desalination device configured as an MEDC, the cathode reaction may be better protected for hydrogen evolution compared to oxygen reduction since chloride, for example, is a problem with Pt catalysts as described in Schmidt, T. J. et al., J. of Electroanalytical Chem. 508, 41-47 (2001).

The hydrogen gas generated in a microbial desalination device configured as an MEDC can be used to power the microbial desalination device in whole or in part, or the gas can be used for other purposes such as electricity generation or as a fuel as examples.

In an MEDC anodophilic microbes can donate electrons to the anode and current flows to the cathode when sufficient voltage is added to that produced by the bacteria. Generally, 0.2 V or more is required to accomplish current generation and hydrogen production at the cathode. In an MFDC current generation can be spontaneous (no applied current) when oxygen reduction is catalyzed on the cathode. In MFDCs, the working potential is typically 0.2-0.5 V, while in an MEDC typically 0.4 to 1 V is applied to the circuit.

In one particular embodiment of the invention, saline water is passed through at least three sections of the reactor, the anode compartment, the cathode compartment, and the saline material compartment containing an aqueous fluid to be desalinated. In the anode compartment, there are microbes that can degrade organic matter, and generate current, and remove the organic matter, thereby “treating” the wastewater to produce “treated” wastewater.

In another embodiment, a method according to the present invention includes wastewater passed into the microbe-containing anode compartment, and saline material into the saline material compartment, with either wastewater, treated wastewater or saline material placed into the cathode compartment. Since, wastewater typically has a low conductivity, for example 1 mS/cm as described in Logan, B. E. et al. Environmental Science & Technology 42, 8630-8640 (2008), there is passive diffusion of anions into the wastewater, even in the absence of current generation, due to osmotic pressure differences between the compartments (i.e. ions move to equilibrate potentials). Thus, in particular embodiments, wastewater containing biodegradable material and having a conductivity lower than the saline material to be desalinated is passed into the anodophilic microbe-containing anode compartment. Wastewater generally has a conductivity of about 1 mS/cm, with a typical range of about 0.4 to 2 mS/cm. Seawater generally has a conductivity of about 50-60 mS/cm, but conductivity of materials used can be lower or higher than these values. This method of operation allows for desalination of the saline material by raising the salinity of the wastewater without use of energy.

The treated wastewater can pass through a compartment with no applied current to allow for passive ion transfer. Treated wastewater can also be recycled into the cathode compartment to aid in charge balance and its reuse instead of using seawater.

The term “wastewater” as used herein refers to water containing organic material, particularly aqueous waste disposed from domestic, municipal, commercial, industrial and agricultural uses. For example, wastewater includes human and other animal biological wastes, and industrial wastes such as food processing wastewater.

Embodiments of systems of the present invention are configured such that wastewater is recycled from the anode compartment to cathode compartment. Flow paths in the anode and cathode compartments can be co-current, i.e. in the direction of the saline water flow through the saline material compartment, or counter-current, i.e. opposite of the saline water flow through the saline material compartment.

Methods of desalination according to embodiments of the present invention can further include one or more additional purification and/or desalination steps, such as reverse osmosis and electrodialysis.

Electrodes Generally

Electrodes included in a microbial desalination device according to the present invention are electrically conductive. Exemplary conductive electrode materials include, but are not limited to, carbon paper, carbon cloth, carbon felt, carbon wool, carbon foam, carbon mesh, activated carbon, graphite, porous graphite, graphite powder, graphite granules, graphite fiber, a conductive polymer, a conductive metal, and combinations of any of these. A more electrically conductive material, such as a metal mesh or screen can be pressed against these materials or incorporated into their structure, in order to increase overall electrical conductivity of the electrode.

An anode and cathode may have any of various shapes and dimensions and are positioned in various ways in relation to each other. In one embodiment, the anode and the cathode each have a longest dimension, and the anode and the cathode are positioned such that the longest dimension of the anode is parallel to the longest dimension of the cathode. In another option, the anode and the cathode each have a longest dimension, and the anode and the cathode are positioned such that the longest dimension of the anode is perpendicular to the longest dimension of the cathode. Further optionally, the anode and the cathode each have a longest dimension, and the anode and the cathode are positioned such that the longest dimension of the anode is perpendicular to the longest dimension of the cathode. In addition, the anode and the cathode may be positioned such that the longest dimension of the anode is at an angle in the range between 0 and 90 degrees with respect to the longest dimension of the cathode.

Electrodes of various sizes and shapes may be included in an inventive system. For example, tubular electrodes can be used as described in Logan, B. E., et al., Environmental Science & Technology 41, 3341-3346 (2007), where the water to be treated flows around tubes containing the water that will contain the higher concentrations of salts (or vice versa). Electrodes can be placed in a co-cylindrical arrangement, or they can be wound as flat sheets into a spiral membrane device.

In general, an anode has a surface having a surface area present in the reaction chamber and the cathode has a surface having a surface area in the reaction chamber. In one embodiment, a ratio of the total surface area of anodes to surface area of cathodes in an inventive system is about 1:1. In one embodiment, the anode surface area in the reaction chamber is greater than the cathode surface area in the reaction chamber. This arrangement has numerous advantages such as lower cost where a cathode material is expensive, such as where a platinum catalyst is included. In addition, a larger anode surface is typically advantageous to provide a growth surface for anodophiles to transfer electrons to the anode. In a further preferred option a ratio of the anode surface area in the reaction chamber to the cathode surface area in the reaction chamber is in the range of 1.5:1-1000:1 and more preferably 2:1-10:1.

Electrodes may be positioned in various ways to achieve a desired spacing between the electrodes.

In preferred embodiments, the electrodes are closely spaced to maximize performance of the system, so the channel width for the saline material can be very thin, such as, but not limited to, 0.05-10 cm.

In further examples, a first electrode may be positioned such that its longest dimension is substantially parallel to the longest dimension of a second electrode. In a further embodiment, a first electrode may be positioned such that its longest dimension is substantially perpendicular with respect to the longest dimension of a second electrode. Additionally, a first electrode may be positioned such that its longest dimension is at an angle between 0 and 90 degrees with respect to the longest dimension of a second electrode.

Optionally, an inventive system is provided which includes more than one anode and/or more than one cathode. For example, from 1-100 additional anodes and/or cathodes may be provided. The number and placement of one or more anodes and/or one or more electrodes may be considered in the context of the particular application. For example, in a particular embodiment where a large volume of substrate is to be metabolized by microbial organisms in a reactor, a larger area of anodic surface may be provided. Similarly, a larger area of cathode surface may be appropriate. In one embodiment, an electrode surface area is provided by configuring a reactor to include one or more electrodes that project into the reaction chamber. In a further embodiment, an electrode surface area is provided by configuring the cathode as a wall of the reactor, or a portion of the wall of the reactor. The ratio of the total surface area of the one or more anodes to the total volume of the interior of the reaction chamber is in the range of about 10000:1-1:1, inclusive, square meters per cubic meter in particular embodiments. In further embodiments, the ratio is in the range of about 5000:1-100:1.

Specific surface area of an electrode included in a microbial desalination device is greater than 100 m²/m³ according to embodiments of the present invention. Specific surface area is here described as the total surface area of the electrode per unit of electrode volume. Specific surface area greater than 100 m²/m³ contributes to power generation in microbial desalination devices according to embodiments of the present invention. In further embodiments, microbial desalination devices according to the present invention include an electrode having a specific surface area greater than 1000 m²/m³. In still further embodiments, microbial desalination devices according to the present invention include an electrode having a specific surface area greater than 5,000 m²/m³. In yet further embodiments microbial desalination devices according to the present invention include an electrode having a specific surface area greater than 10,000 m²/m³. An electrode configured to have a high specific surface area allows for scaling of a microbial desalination device according to the present invention.

A high specific surface area electrode is configured as a mesh of carbon-based material or a brush in particular embodiments.

Anodes

Typically, an anode provides a surface for attachment and growth of anodophilic bacteria and therefore an anode is made of material compatible with bacterial growth and maintenance. Compatibility of a material with bacterial growth and maintenance in a microbial fuel cell may be assessed using standard techniques such as assay with a viability marker such as Rhodamine 123, propidium iodide, SYTO 9 and combinations of these or other bacteria viability markers.

An anode included in embodiments of a microbial desalination device according to the present invention includes fibers of a conductive anode material, providing a large surface area for contact with bacteria in a microbial fuel cell.

Specific surface area of an anode included in a microbial desalination device is greater than 100 m²/m³ according to embodiments of the present invention. Specific surface area is here described as the total surface area of the anode per unit of anode volume. Specific surface area greater than 100 m²/m³ contributes to power generation in microbial desalination devices according to embodiments of the present invention. In further embodiments, microbial desalination devices according to the present invention include an anode having a specific surface area greater than 1000 m²/m³. In still further embodiments, microbial desalination devices according to the present invention include an anode having a specific surface area greater than 5.000 m²/m³. In yet further embodiments, microbial desalination devices according to the present invention include an anode having a specific surface area greater than 10,000 m²/m³. An anode configured to have a high specific surface area allows for scaling of a microbial desalination device according to the present invention.

A high specific surface area anode is configured as a mesh of carbon-based material in particular embodiments.

A brush anode is provided in particular embodiments which has a specific surface area greater than 100 m²/m³. A brush anode includes one or more conductive fibers. In particular embodiments the one or more fibers are attached to a support.

A plurality of fibers is attached to the support and the fibers extend generally radially from the support in specific embodiments. A brush anode optionally includes a centrally disposed support having a longitudinal axis.

Brush anodes include a variety of configurations illustratively including various twisted wire brush configurations and strip brush configurations. For example, a particular twisted wire brush configuration includes a support formed from two or more strands of wire and fibers attached between the wires. In a further example, a strip brush configuration includes fibers attached to a conductive backing strip, the strip attached to the support.

Fibers of a brush anode are electrically conductive and are in electrical communication with the support and with a cathode. In particular embodiments, fibers and/or support of a brush anode provide a support for colonization by anodophilic bacteria, such that the brush anode is preferably substantially non-toxic to anodophilic bacteria.

In particular embodiments, fibers of a brush anode include a metallic and/or non-metallic conductive material which is substantially non-toxic to anodophilic bacteria. In a specific example, fibers include carbon fibers. Carbon fibers are optionally substantially composed of graphite. In a further option, a carbon material is mixed with a conductive polymer to form a fiber. In still further embodiments, a polymer fiber is coated with a conductive carbon material.

The carbon fibers or other carbon material may be heated in order to remove compounds that can interfere with power generation. Carbon mesh active surface area and charge transfer coefficient can be measured to determine the optimal time and temperature for heat treatment to reduce compounds that can interfere with power generation. In one example, heating the carbon fibers or other carbon material to 450 deg C. for 30 minutes removes material that can interfere with power generation.

A brush anode electrode may include any of various coatings. In particular embodiments a coating is included on a brush anode to increase the efficiency of power production by bacteria on the anode. For example, a brush anode electrode may be coated with a material which increases the conductivity of electrons from bacteria to a surface. Examples of materials which increase the conductivity of electrons from bacteria to a surface include, but are not limited to, neutral red, Mn⁴⁺, Fe₃O₄, Ni2⁺, fluorinated polyanilines, such as poly(2-fluoroaniline) and poly(2,3,5,6-tetrafluoroaniline) for example, anthraquinone-1,6-disolfonic acid (AQDS), 1,4-naphthoquinone (NQ), and combinations of any of these.

In a particular embodiment, an anode is treated with an ammonia gas process to increase power production and reduce the time needed to generate substantial power once the reactor is inoculated. For example, a brush anode is treated with a heated ammonia gas, such as NH₃ gas. In a specific embodiment, a brush anode is heated to 700° C. and incubated with NH₃ gas for about one hour.

Additional materials are optionally included in a brush anode, for example to strengthen and support the graphite fibers or to help clean the system by removing biofilm in cases where the brushes can be moved around or swirled to clean the adjoining surfaces, cathodes or other materials.

Cathodes

A cathode included in a microbial desalination device according to embodiments of the present invention may be configured to be immersed in liquid or as a gas cathode, having a surface exposed to a gas. A cathode preferably includes an electron conductive material. Materials included in a cathode included in an inventive system illustratively include, but are not limited to, carbon paper, carbon cloth, carbon felt, carbon wool, carbon foam, graphite, porous graphite, graphite powder, activated carbon, a conductive polymer, a conductive metal, and combinations of any of these.

In particular embodiments, a cathode included in a microbial desalination device of the present invention is an air cathode, also known as a gas cathode.

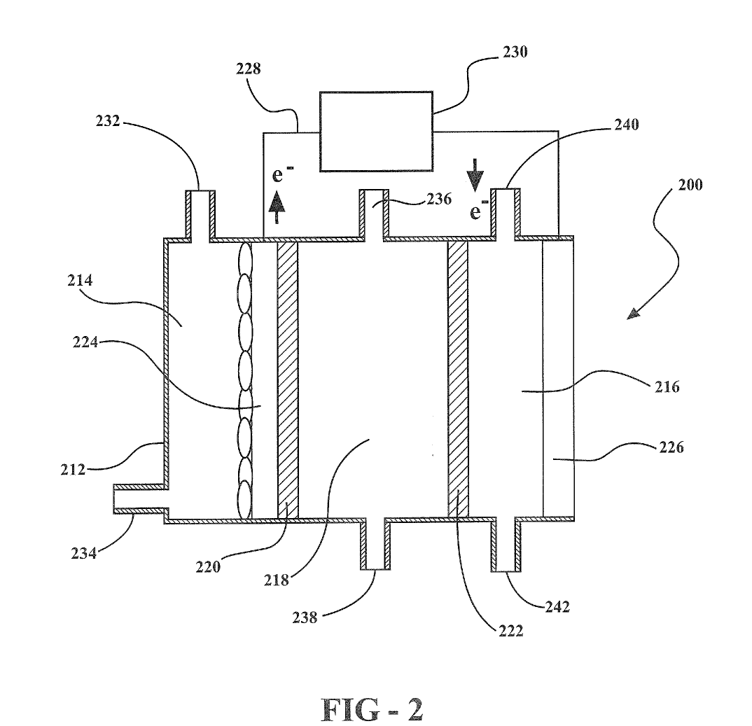

FIG. 2 illustrates an embodiment of an inventive system 200 including an air cathode. In this illustration, a reaction chamber is shown having a wall 212 defining the interior and exterior of the reaction chamber. The reaction chamber shown has three compartments, an anode compartment 214, a cathode compartment 216 and a saline material compartment 218 disposed between the anode compartment 214 and cathode compartment 216. An anode exchange membrane 220 is disposed between the anode compartment 214 and the saline material compartment 218. A cathode exchange membrane 222 is disposed between the cathode compartment 216 and the saline material compartment 218. An anode having bacteria disposed thereon is shown at 224. An air cathode is shown at 226. A conduit for electrons 228 is shown along with a connected power source and/or load is shown at 230. One or more channels for inlet and outlet of materials, such as gases, an organic substance oxidizable by the anodophilic bacteria or saline material can be included, examples are shown at 232, 234, 236, 238, 240 and 242.

In particular embodiments, a cathode included in a microbial desalination device of the present invention is a biocathode and thus not require a metal catalyst on the cathode Biocathodes are electrodes containing bacteria that are capable of accepting electrons, called exoelectrotrophs, from the electrode, and transferring them to a chemical that accepts those electrons such as oxygen, nitrate or carbon dioxide. Biocathodes have been developed for hydrogen evolution as described in Rozendal, R. A. et al., Environmental Science & Technology 42, 629-634 (2008), oxygen reduction as described in Clauwaert, P. et al. Environmental Science & Technology 41, 7564-7569 (2007), methane generation as described in Cheng, S. et al., Environmental Science & Technology, doi: 10.1021/es803531g,) and nitrate reduction Clauwaert, P. et al., Environmental Science & Technology 41, 3354-3360 (2007).

Optionally, the cathode includes a membrane and the membrane forms a cathode wall. The cathode wall has an external surface and an internal surface and the wall defines an interior space adjacent to the internal surface and an exterior adjacent to the external surface. The cathode wall forms a shape which is generally cylindrical in particular embodiments. In further particular embodiments, the shape formed by the cathode wall is generally slab or brick-shaped, having a hollow interior. Other hollow shapes are also possible, illustratively including hollow disc-shaped.

A membrane forming a cathode wall is a porous membrane. The membrane is sufficiently porous to allow diffusion of a desired material through the membrane. For example, an included membrane is porous to oxygen, protons and/or hydrogen gas in particular embodiments of an inventive microbial fuel cell. In specific embodiments of an electricity generating configuration of a microbial fuel cell, an included membrane is porous to oxygen and protons. In specific embodiments of a hydrogen generating modified microbial fuel cell, an included membrane is porous to protons where a catalyst is present on or adjacent to the internal surface of the membrane. In further specific embodiments of a hydrogen gas generating modified microbial fuel cell, an included membrane is porous to protons and hydrogen gas where a catalyst is present on or adjacent to the external surface of the membrane. In preferred embodiments, the effective pores of an included membrane are smaller than the size of a typical bacterium, about 1000 nanometers. Thus, the flow of water and/or bacteria through the membrane and any included membrane coatings is restricted.

A membrane included in a cathode of the present invention is not limited as to the material included in the membrane. Microfiltration, nanofiltration and ion exchange membrane compositions are known in the art and any of various membranes may be used which exclude bacteria and allow diffusion of a desired gas through the membrane. Illustrative examples of microfiltration, nanofiltration and/or ion exchange membrane compositions include, but are not limited to, halogenated compounds such as tetrafluoroethylene, tetrafluoroethylene copolymers, tetrafluoroethylene-perfluoroalkylvinylether copolymers, polyvinylidene fluoride, polyvinylidene fluoride copolymers, polyvinyl chloride, polyvinyl chloride copolymers; polyolefins such as polyethylene, polypropylene and polybutene; polyamides such as nylons; sulfones such as polysulfones and polyether sulfones; nitrile-based polymers such as acrylonitriles; and styrene-based polymers such as polystyrenes.

A membrane optionally includes a structural support layer such as a porous plastic backing layer. For example, a membrane is optionally supported on a polyester layer. A support layer is flexible in preferred embodiments.

Examples of suitable membrane materials are ultrafiltration and nanofiltration membranes commonly employed in the water treatment industry to filter water while excluding bacteria. For example, a suitable membrane is ultrafiltration membrane B 0125 made by X-Flow, The Netherlands. Additional examples include CMI and AMI ion exchange membranes made by Membranes International, Inc. New Jersey, USA.

A membrane included in an inventive cathode includes a conductive material such that the membrane is electrically conductive and/or the membrane is coated on one side with a conductive material.

In particular configurations, one or more coatings are applied to the membrane in order to allow the material to become electrically conductive. For example, a metal or carbon containing coating is optionally applied to at least a portion of one side of the membrane. In a particular embodiment, a graphite coating is applied. An exemplary formulation of a graphite coating includes products of Superior Graphite, formulations ELC E34, Surecoat 1530.

Optionally, a membrane material is fabricated to include an electrically conductive material in the membrane, rendering a membrane made from the material electrically conductive. For example, carbon fibers may be mixed with a polymer typically used in an ultrafiltration, nanofiltration and/or ion exchange membrane.

Optionally, a catalyst for enhancing a desired reaction at the cathode is included in a cathode according to the present invention. Thus, a catalyst for enhancing reduction of oxygen is included in an electricity producing configuration of a microbial fuel cell. Further, a catalyst for enhancing reduction of protons to hydrogen gas, that is enhancing a hydrogen evolution reaction, is included in a hydrogen gas producing configuration of a microbial fuel cell. An included catalyst typically enhances the reaction kinetics, e.g. increases the rate of oxygen and/or proton reduction. In addition, a catalyst reduces a need for applied potential, the overpotential, for initiating oxygen and/or hydrogen reduction.

A catalyst is optionally applied to a conductive membrane. In a further option, a catalyst is mixed with a conductive material to form a mixture which is applied to a membrane. In a further option, a catalyst is applied to the membrane before or after application of a conductive material.

In particular embodiments, a catalyst is optionally mixed with a polymer and a conductive material such that a membrane includes a conductive catalyst material integral with the membrane. For example, a catalyst, is mixed with a graphite coating material and the mixture is applied to a cathode membrane.

Suitable catalysts are known in the art and include metal catalysts, such as a noble metal. Suitable catalyst metals illustratively include platinum, nickel, copper, tin, iron, palladium, cobalt, tungsten, and alloys of such metals. While a catalyst metal such as platinum is included in a cathode in one embodiment of an inventive system, the platinum content may be reduced, for example to as little as 0.1 mg/cm² without affecting energy production. In further embodiments, an included catalyst includes a non-noble metal containing catalyst such as CoTMPP and/or activated carbon.

One or more additional coatings may be placed on one or more electrode surfaces. Such additional coatings may be added to act as diffusion layers, for example. A cathode protective layer, for instance, may be added to prevent contact of bacteria or other materials with the cathode surface while allowing oxygen diffusion to the catalyst and conductive matrix. In further embodiments, a cathode protective layer is included as a support for bacterial colonization such that bacteria scavenge oxygen in the vicinity of the cathode but do not directly contact the cathode.

A tube cathode included in an MEDC configuration of a microbial desalination device according to embodiments of the present invention is open at one or both ends of its length to an oxygen-containing medium. In particular embodiments, a tube cathode included in an MEDC configuration of a microbial desalination device is open at one or both ends to ambient air.

A tube cathode included in an MEDC configuration of a microbial desalination device according to embodiments of the present invention is open at one end of its length to a receptacle or conduit for collection or passage of generated hydrogen gas.

As described above, a tube cathode according to the present invention has an interior space. The interior space of a tube cathode included in a microbial fuel cell configured for hydrogen generation according to embodiments of the present invention may be gas filled in one option. Thus, for example, the interior space of a tube cathode may initially contain ambient air at start-up and contain increased amounts of hydrogen as hydrogen generation proceeds during operation of the hydrogen generating microbial fuel cell. The generated hydrogen flows from the interior space of the tube cathode, for instance to a gas collection unit or device. In a further embodiment, the interior space is filled or partially filled with a liquid. Hydrogen generated during operation of the hydrogen generating microbial fuel cell moves from the liquid containing interior space, for instance to a gas collection unit or device, efficiently with little back pressure into the liquid in the interior space. The inclusion of a liquid in a tube cathode aids in hydrogen evolution since it results in phase separation of the hydrogen gas and liquid, reducing back diffusion into the anode compartment. Larger amounts of hydrogen are recovered using a liquid in the cathode interior space. A liquid included in the interior space may be any of various liquids compatible with the cathode materials and with hydrogen gas. Suitable liquids include aqueous liquids, such as water, which may contain one or more salts, buffers, or other additives.

In some embodiments, the cathode is operated so that water is pulled through the porous membrane material of the cathode, allowing contact of the water with the conductive coating or conductive matrix of the membrane. The membrane material can be enriched with carbon black to make it conductive, made with graphite fibers, or coated in a way that still permits water flow through the device.

Optionally, and preferably in some embodiments, the cathode is a gas cathode. In particular embodiments, an included cathode has a planar morphology, such as when used with a brush anode electrode. In this configuration, the cathode is preferably a gas diffusion electrode.

Optionally, an included cathode is disposed in an aqueous medium, with dissolved oxygen in the medium serving to react at the cathode.

In one embodiment of the invention a cathode membrane is substantially impermeable to water.

In particular embodiments, the cathode contains one or more cathode shielding materials. Such a shielding material may preferably include a layer of a shielding material disposed on any cathode surface, including an inner cathode surface, that is, a cathode surface present in the interior volume of the reaction chamber, and an outer surface, that is, a cathode surface exterior to the reaction chamber. A cathode surface exterior to the reaction chamber is likely to be present where a gas cathode is used, where the exterior cathode surface is in contact with a gas. Thus, in one embodiment an outer surface of a cathode is covered partially or preferably wholly by a cathode diffusion layer (CDL). The CDL may be directly exposed to the gas phase and is preferably bonded to the cathode to prevent water leakage through the cathode from the interior of the reaction chamber. Further, in MEDC configuration of a microbial desalination device, the CDL is hydrogen permeable, allowing hydrogen to freely diffuse from the catalyst in the cathode into a gas collection chamber, gas conduit or other component of a gas collection system. A CDL may further provide support for the cathode and may further form a portion of a wall of a reaction chamber. A CDL can also help to reduce bacteria from reaching the cathode and fouling the surface. A CDL includes a hydrogen permeable hydrophobic polymer material such as polytetrafluoroethylene (PTFE) or like materials. The thickness of this material can be varied or multiple layers can be applied depending on the need to reduce water leakage.

In a further embodiment, an inner cathode surface is protected by a cathode protection layer (CPL). A function of the CPL is to protect the cathode from biofouling of the catalyst. Further, a CPL reduces diffusion of carbon dioxide to the cathode so as to limit methane formation from both abiotic and biotic sources, or from the action of bacteria, at the cathode. A CPL further acts to provide a support for bacterial colonization in the vicinity of the cathode, allowing for scavenging of oxygen in the cathode area without biofouling.

In one embodiment, a CPL is configured such that it is in contact with an inner surface of a cathode. Thus, for instance, a CPL may be configured to cover or surround the inner surface of the cathode partially or wholly, such as by bonding of the CPL to the cathode.

In a further embodiment, a CPL is present in the interior of the reaction chamber but not in contact with the cathode. The inclusion of such a CPL defines two or more regions of such a reactor based on the presence of the CPL. The CPL can be proton, liquid, and/or gas permeable barriers, such as a filter. For example, a filter for inhibiting introduction of large particulate matter into the reactor may be positioned between the anode and cathode such that material flowing through the reaction chamber between the anode and cathode passes through the filter. Alternatively or in addition, a filter may be placed onto the cathode, restricting the passage of bacteria-sized particles to the cathode and the catalyst. Further, a filter may be positioned between an inlet channel and/or outlet channel and the interior of the reaction chamber or a portion thereof. Suitable filters may be configured to exclude particles larger than 0.01 micron-1 micron for example. A CPL may also include material that aids bacterial attachment, so that bacteria can scavenge dissolved oxygen that can leak into the system.

Ion Exchange Materials

A cation exchange material is permeable to one or more selected cations. Cation exchange material is disposed between the cathode compartment and the saline material compartment forming a cation selective barrier between the cathode compartment and the saline material compartment. According to embodiments of the present invention, the cation exchange material is in the form of a cation exchange membrane. Cation exchange materials include, but are not limited to, ion-functionalized polymers exemplified by perfluorinated sulfonic acid polymers such as tetrafluoroethylene and perfluorovinylether sulfonic acid copolymers, and derivatives thereof; sulfonate-functionalized poly(phenylsulfone); and sulfonate-functionalized divinylbenzene cross-linked poly(styrene). Specific examples include NAFION, such as NAFION 117, and derivatives produced by E.I. DuPont de Nemours & Co., Wilmington, Del. Cation exchange materials include, for example, CMI cation exchange membranes made by Membranes International, Inc. New Jersey, USA. Also suitable are other varieties of sulfonated copolymers, such as sulfonated poly(sulfone)s, sulfoanted poly(phenylene)s, and sulfonated poly(imides)s, and variations thereof.

An anion exchange material is permeable to one or more selected anions. Anion exchange material is disposed between the anode compartment and the saline material compartment forming an anion selective barrier between the anode compartment and the saline material compartment. According to embodiments of the present invention, the anode exchange material is in the form of an anion exchange membrane.

Anion exchange materials include, for example, quaternary ammonium-functionalized poly(phenylsulfone); and quaternary ammonium-functionalized divinylbenzene cross-linked poly(styrene). Further examples include AMI ion exchange membranes made by Membranes International, Inc. New Jersey, USA. Tokuyama Corporation, JAPAN, also produces a range of anion exchange membranes such as AHA and A201 that can be included in a system according to embodiments of the invention. Fumatech, GERMANY, anion exchange membranes, FAA, can be included in a system according to embodiments of the invention.

Catalyst

Optionally, a catalyst for enhancing a desired reaction at the cathode is included in a cathode according to the present invention. Thus, a catalyst for enhancing reduction of oxygen is included in an MFDC configuration of a microbial desalination device according to embodiments of the present invention. Further, a catalyst for enhancing reduction of protons to hydrogen gas, that is enhancing a hydrogen evolution reaction, is included in an MEDC configuration of a microbial desalination device according to embodiments of the present invention. An included catalyst typically enhances the reaction kinetics, e.g. increases the rate of oxygen and/or proton reduction. In addition, a catalyst reduces a need for applied potential, the overpotential, for initiating oxygen and/or hydrogen reduction.

Suitable catalysts are known in the art and include metal catalysts, such as a noble metal. Suitable catalyst metals illustratively include platinum, nickel, copper, tin, iron, palladium, cobalt, tungsten, and alloys of such metals. While a catalyst metal such as platinum is included in a cathode in one embodiment of an inventive system, the platinum content may be reduced, for example to as little as 0.1 mg/cm² without affecting energy production. In further embodiments, an included catalyst includes a non-noble metal containing catalyst such as CoTMPP.

In particular embodiments, a microbial desalination device configured as a MFDC includes an activated carbon material which provides high specific surface area for oxygen reduction.

For microbial desalination devices configured as MEDCs to produce hydrogen at the cathode, stainless steel and/or nickel can be included in particular embodiments.

Microbes

Anodophilic microbes are included in microbial desalination devices of the present invention. Anodophilic microbes included in embodiments of a microbial desalination devices of the present invention include at least one or more species of anodophilic bacteria. The terms “anodophiles” and “anodophilic bacteria” as used herein refer to bacteria that transfer electrons to an electrode, either directly or by endogenously produced mediators. In general, anodophiles are obligate or facultative anaerobes. The term “exoelectrogens” is also used to describe suitable bacteria. Examples of anodophilic bacteria include bacteria selected from the families Aeromonadaceae, Alteromonadaceae, Clostridiaceae, Comamonadaceae, Desulfuromonaceae, Enterobacteriaceae, Geobacteraceae, Pasturellaceae, and Pseudomonadaceae. These and other examples of bacteria suitable for use in an inventive system are described in Bond, D. R., et al., Science 295, 483-485, 2002; Bond, D. R. et al., Appl. Environ. Microbiol. 69, 1548-1555, 2003; Rabaey, K., et al., Biotechnol, Lett. 25, 1531-1535, 2003; U.S. Pat. No. 5,976,719; Kim, H. J., et al., Enzyme Microbiol. Tech. 30, 145-152, 2002; Park, H. S., et al., Anaerobe 7, 297-306, 2001; Chauduri, S. K., et al., Nat. Biotechnol., 21:1229-1232, 2003; Park, D. H. et al., Appl. Microbiol. Biotechnol., 59:58-61, 2002; Kim, N. et al., Biotechnol. Bioeng., 70:109-114, 2000; Park, D. H. et al., Appl. Environ. Microbiol., 66, 1292-1297, 2000; Pham, C. A. et al., Enzyme Microb. Technol., 30: 145-152, 2003; and Logan, B. E., et al., Trends Microbiol., 14 (12):512-518.

Anodophilic bacteria preferably are in contact with an anode for direct transfer of electrons to the anode. However, in the case of anodophilic bacteria which transfer electrons through a mediator, the bacteria may be present elsewhere in the reactor and still function to produce electrons useful in an inventive process.

Anodophilic bacteria may be provided as a purified culture, enriched in anodophilic bacteria, or even enriched in a specified species of bacteria, if desired. Pure culture tests have reported Coulombic efficiencies as high as 98.6% in Bond, D. R. et al., Appl. Environ. Microbiol. 69, 1548-1555, 2003. Thus, the use of selected strains may increase overall electron recovery and hydrogen production, especially where such systems can be used under sterile conditions. Bacteria can be selected or genetically engineered that can increase Coulombic efficiencies and potentials generated at the anode.

Further, a mixed population of bacteria may be provided, including anodophilic anaerobes and other bacteria.

Biodegradable Substrates

A biodegradable substrate included in a microbial desalination device according to embodiments of the present invention is oxidizable by anodophilic bacteria or biodegradable to produce a material oxidizable by anodophilic bacteria.

Anodophilic bacteria can oxidize certain inorganic as well as organic materials. Inorganic materials oxidizable by anodophilic bacteria are well-known in the art and illustratively include hydrogen sulfide.

A biodegradable substrate is an organic material biodegradable to produce an organic substrate oxidizable by anodophilic bacteria in some embodiments. Any of various types of biodegradable organic matter may be used as “fuel” for bacteria in a MFDC, including carbohydrates, amino acids, fats, lipids and proteins, as well as animal, human, municipal, agricultural and industrial wastewaters. Naturally occurring and/or synthetic polymers illustratively including carbohydrates such as chitin and cellulose, and biodegradable plastics such as biodegradable aliphatic polyesters, biodegradable aliphatic-aromatic polyesters, biodegradable polyurethanes and biodegradable polyvinyl alcohols. Specific examples of biodegradable plastics include polyhydroxyalkanoates, polyhydroxybutyrate, polyhydroxyhexanoate, polyhydroxyvalerate, polyglycolic acid, polylactic acid, polycaprolactone, polybutylene succinate, polybutylene succinate adipate, polyethylene succinate, aliphatic-aromatic copolyesters, polyethylene terephthalate, polybutylene adipate/terephthalate and polymethylene adipate/terephthalate.

Organic substrates oxidizable by anodophilic bacteria are known in the art. Illustrative examples of an organic substrate oxidizable by anodophilic bacteria include, but are not limited to, monosaccharides, disaccharides, amino acids, straight chain or branched C₁-C₇ compounds including, but not limited to, alcohols and volatile fatty acids. In addition, organic substrates oxidizable by anodophilic bacteria include aromatic compounds such as toluene, phenol, cresol, benzoic acid, benzyl alcohol and benzaldehyde. Further organic substrates oxidizable by anodophilic bacteria are described in Lovely, D. R. et al., Applied and Environmental Microbiology 56:1858-1864, 1990. In addition, a provided substrate may be provided in a form which is oxidizable by anodophilic bacteria or biodegradable to produce an organic substrate oxidizable by anodophilic bacteria.

Specific examples of organic substrates oxidizable by anodophilic bacteria include glycerol, glucose, acetate, butyrate, ethanol, cysteine and combinations of any of these or other oxidizable organic substances.

The term “biodegradable” as used herein refers to an organic material decomposed by biological mechanisms illustratively including microbial action, heat and dissolution. Microbial action includes hydrolysis, for example.

Mediators

Optionally, a mediator of electron transfer is included in a microbial desalination device. Such mediators are exemplified by ferric oxides, neutral red, anthraquinone-1,6-disulfonic acid (ADQS) and 1,4-napthoquinone (NQ). Mediators are optionally chemically bound to the anode, or the anode modified by various treatments, such as coating, to contain one or more mediators.

General Aspects of Microbial Desalination Devices

A microbial desalination device according to the present invention may be configured as a self-contained device in particular embodiments. Thus, for example, a quantity of a biodegradable substrate is included in the microbial desalination device and no additional substrate is added. In further options, additional substrate is added at intervals or continuously such that the microbial desalination device operates as a batch processor or as a continuous flow system.

An embodiment of an MEDC configuration of a microbial desalination device is a completely anaerobic system to generate hydrogen at the cathode by providing a small added voltage to the circuit. This approach to electrochemically assist hydrogen production is based on separating the two electrodes into half cell reactions. The potential of the anode is set by the oxidation of a substrate. Thus, the anode side of an embodiment of an MEDC configuration of a microbial desalination device operates similarly to that in a MFDC bacteria oxidize an organic compound completely to CO₂ and transfer electrons to the anode. The half reaction potential measured at the anode in an embodiment of an inventive system tests as −480 mV (Ag/AgCl) or −285 mV (NHE) (reduction).

In contrast, cathode operation in an embodiment of an MEDC configuration of a microbial desalination device is significantly altered from that in an MFDC. By electrochemically augmenting the cathode potential in the circuit it is possible to directly produce hydrogen from protons and electrons produced by the bacteria. This approach greatly reduces the energy needed to make hydrogen directly from organic matter compared to that required for hydrogen production from water via electrolysis. In addition, the use of the produced hydrogen from an MEDC to provide power to a microbial desalination device can allow higher voltages to be applied, and thus increase the rate of desalination or to desalinate several compartments. In a typical MFDC, the open circuit potential of the anode is ˜−300 mV. Where hydrogen is produced at the cathode, the half reactions occurring at the anode and cathode, with acetate oxidized at the anode, are:

Anode: C₂H₄O₂+2H₂O→2CO₂+8e⁻+8H⁺

Cathode: 8H⁺+8e⁻→4H₂

Power Source

A power source for enhancing an electrical potential between the anode and cathode is included in embodiments of microbial desalination devices. Power is added to MEDC configurations of systems of the present invention to produce hydrogen. No power is required to be added in MFDC configurations and may be added if desired. Power added to an MEDC or MFDC can be used to enhance the rate of desalination of a saline material if desired. Power sources used for enhancing an electrical potential between the anode and cathode are not limited and illustratively include grid power, solar power sources, wind power sources. Further examples of a power source suitable for use in an inventive system illustratively include a DC power source and an electrochemical cell such as a battery or capacitor.

In a particular embodiment, a power supply for an MEDC configuration of a microbial desalination device is an electricity-producing microbial fuel cell.

In preferred embodiments, hydrogen produced by an MEDC or desalination device configured as an MEDC can be used as the fuel for the power source.

In a preferred embodiment, power is supplied by including a reference electrode and setting the anode potential.

Gas Collection

A gas collection system is optionally included in microbial desalination device according to embodiments of the present invention.

Gases such as hydrogen, methane and carbon dioxide can be collected and may be stored for use, or directed to a point of use, such as to a hydrogen or methane fuel powered device.

For example, a gas collection unit may include one or more gas conduits for directing a flow of gas from the cathode or cathode compartment to a storage container or directly to a point of use.

A gas conduit is optionally connected to a source of a sweep gas. For instance, as a gas is initially produced, a sweep gas may be introduced into a gas conduit, flowing in the direction of a storage container or point of gas use.

For instance, a gas collection system may include a container for collection of hydrogen from the cathode. A collection system may further include a conduit for passage of gas. The conduit and/or container may be in gas flow communication with a channel provided for outflow of gas from the reaction compartment. Typically, the conduit and/or container are in gas flow communication with the cathode, particularly where the cathode is a gas cathode.

Gas produced from the anode is CO₂ rich and can be delivered to the cathode compartment to lower pH in the cathode compartment, thereby regulating and maintaining appropriate pH in both anode and cathode compartments during operation, in particular embodiments.

Reaction Conditions

An aqueous medium in an anode or cathode compartment of the reaction compartment of embodiments of a microbial desalination device is formulated to be non-toxic to bacteria in contact with the aqueous medium. Further, the medium or solvent may be adjusted to a be compatible with bacterial metabolism, for instance by adjusting pH to be in the range between about pH 3-9, preferably about 5-8.5, inclusive, by adding a buffer to the medium or solvent if necessary, and by adjusting the osmolarity of the medium or solvent by dilution or addition of a osmotically active substance. Ionic strength may be adjusted by dilution or addition of a salt for instance. Further, nutrients, cofactors, vitamins and other such additives may be included to maintain a healthy bacterial population, if desired, see for example examples of such additives described in Lovley and Phillips, Appl. Environ. Microbiol., 54 (6):1472-1480. Optionally, an aqueous medium in contact with anodophilic bacteria contains a dissolved substrate oxidizable by the bacteria.

In operation, reaction conditions include variable such as pH, temperature, osmolarity, and ionic strength of the medium in the reactor. In general, the pH of the medium in the reactor is between 3-9, inclusive, and preferably between 5-8.5, inclusive.

Reaction temperatures are typically in the range of about 10-40° C. for non-thermophilic bacteria, although the device may be used at any temperature in the range of 0 to 100° C., inclusive by including suitable bacteria for growing at selected temperatures. However, maintaining a reaction temperature above ambient temperature may require energy input and it is preferred to maintain the reactor temperature at about 15-25° C., inclusive without input of energy. Reaction temperatures in the range of 16-25° C., inclusive or more preferably temperatures in the range of 18-24° C., inclusive and further preferably in the range of 19-22° C., inclusive, allow hydrogen generation, electrode potentials, Coulombic efficiencies and energy recoveries comparable to reactions run at 32° C. which is generally believed to be an optimal temperature for anaerobic growth and metabolism, including oxidation of an organic material.

In particular embodiments, an aqueous saline material to be desalinated has a salt concentration in the range of 2 to 40 g/L of salt.

Reaction Chamber and Associated Components

A channel is included defining a passage from the exterior of the reaction chamber to the interior in particular embodiments. More than one channel may be included to allow and/or regulate flow of materials into and out of the reaction chamber. For example, a channel may be included to allow for outflow of a gas generated at the cathode. Further, a channel may be included to allow for outflow of a gas generated at the anode.

In a particular embodiment of a continuous flow configuration, a channel may be included to allow flow of a substance into a reaction chamber and a separate channel may be used to allow outflow of a substance from the reaction chamber. More than one channel may be included for use in any inflow or outflow function.

A regulator device, such as a valve, may be included to further regulate flow of materials into and out of the reaction chamber. Further, a cap or seal is optionally used to close a channel. For example, where a fuel cell is operated remotely or as a single use device such that no additional materials are added, a cap or seal is optionally used to close a channel.

A pump may be provided for enhancing flow of liquid or gas into and/or out of a reaction chamber.

Embodiments of inventive compositions and methods are illustrated in the following examples. These examples are provided for illustrative purposes and are not considered limitations on the scope of inventive compositions and methods.

### EXAMPLES

An air-cathode MFDC containing three equally-sized compartments is used in this example. The MFDC was constructed from three blocks of Lexan, each 2 cm long, each machined to contain a cylindrical compartment 3 cm in diameter (14 mL each).

In this example, ion-functionalized divinylbenzene cross-linked poly(styrene) (PS) and ion-functionalized poly(phenylsulfone) (PFS) were compared as anion exchange materials and cation exchange materials. The charge-bearing functional groups were the same for both anion exchange materials: quaternary ammonium chloride. Quaternary ammonium-functionalized PS was used in the form of an anion exchange membrane (AEM), commercially available as AMI-7001 from Membranes International Inc., NJ. Quaternary ammonium-functionalized PFS AEMs were prepared by chloromethylation of commercially available RADEL® poly(phenylsulfone), Solvay Advanced Polymers, Alpharetta, Ga. Chloromethylation of RADEL poly(phenylsulfone) was achieved through the addition of ZnCl₂, SOCl₂, and (CH₃O)₂CH₃ to a solution of the polymer in tetrachloroethane as described in Hibbs, M. R. et al., Chem. Mater. 2008, 20, 7, 2566-2573. Other methods of chloromethylation to form anion exchange membranes include addition of CH₂ClOCH₃ as described in Zschocke, P. et al., J. Membr. Sci. 1985, 22, 2-3, 325-332 or CH₂ClOC₈H₁₇ as described in Warshawsky, A. et al., J. Membr. Sci. 1990, 53, 1-2, 37-44 to a solution of the polymer. Reaction of paraformaldahyde, SnCl₄, and (CH₃)₃SiCl, with a solution of the polymer as described in Avram, E. et al., J. Macromol. Sci.-Pure Appl. Chem. 1997, A34, 9, 1701-1714 or the use of quaternary ammonium containing monomers as described in Clark, T. J. et al., J. Am. Chem. Soc. 2009, 131, 36, 12888-12889 or precursor groups to quaternary ammonium moieties as described in Yan, J. L. et al., Macromolecules, 2010, 43, 5, 2349-2356 are all routes to produce anion exchange membranes.

After chloromethylation, the chloromethylated RADEL was converted to quaternary ammonium by addition of 3× molar excess (based on chloromethyl content of the polymer) 45 wt % aqueous trimethyl amine to a solution of the chloromethylated RADEL in dimethylformamide. After 24 h of contacting the chloromethylated RADEL with aqueous trimethyl amine, all of the chloromethyl groups were converted to benzyl trimethylammonium moieties and the polymers were then cast from dimethylformamide at room temperature for 48 h and then dried under full vacuum at 50° C. for an additional 24 h to form solid polymer membranes 20 to 300 microns thick.

The charge-bearing functional groups were the same for both cation exchange materials: sodium sulfonate. Sodium sulfonate-functionalized PS was used in the form of a cation exchange membrane (CEM), commercially available as CMI-7000 from Membranes International Inc., NJ. Sodium sulfonate-functionalized PFS CEM were prepared by sulfonation of commercially available RADEL® poly(phenylsulfone), Solvay Advanced Polymers, Alpharetta, Ga. Sulfonation was accomplished by addition of trimethylsilyl chlorosulfonate to a solution of RADEL in tetrachloroethane as described in Dyck, A. et al., J. Appl. Polym. Sci. 2002, 86, 11, 2820-2827. Other sulfonation procedures for polymers, such as described in Hickner, M. A. et al., Chem. Rev. 2004, 104, 10, 4587-4611 and Iojoiu, C. et al., Fuel Cells 2005, 5, 3, 344-354, or the use of sulfonated monomers, as described in Wang, F. et al., J. Membr. Sci. 2002, 197, 1-2, 231-242, may also be employed to achieve similar sulfonated polymers. The sulfonated polymers were dissolved in dimethylformamide and cast into 20-300 micron thick membranes by drying at 60° C. for 2 h, then 80° C. for 2 h in an atmospheric environment followed by drying in a vacuum oven at 80° C. for 5 h.

Ion-functionalized PS AEM and CEM membranes both had a thickness of 0.46 mm. Ion-functionalized PFS membranes thicknesses of 0.041 mm (AEM) and 0.066 mm (CEM) to decrease the ohmic resistance. Ion-functionalized PFS membranes had higher ion exchange capacity (AEM, 2.05 meq/g; CEM, 1.76 meq/g) than the ion-functionalized PS membranes (AEM, 1.0 meq/g; CEM, 1.3 meq/g). All membranes were preconditioned by immersion in a 0.5 M NaCl solution overnight, then rinsing in distilled water.

The anodes were ammonia-treated carbon cloth (BASF, NJ) prepared as described in S. Cheng et al., Electrochem. Comm., 2007, 9, 492-496. Cathodes were made by applying platinum (0.5 mg/cm² Pt) and four PTFE diffusion layers on a 30% wet-proofed carbon cloth (type B-1B, E-TEK) as described in S. Cheng et al, Electrochem. Comm., 2006, 8, 489-494. Both electrodes had the same projected surface area of 7 cm².

Microorganisms and Medium

MFDCs were inoculated (50% v/v) with a pre-acclimated suspension of bacteria from an existing MFDC. The medium used for the anode compartment contained sodium acetate (1 or 2 g/L) in a nutrient medium containing a 50 mM PBS buffer solution (PBS; 4.58 g Na₂HPO₄, 2.45 g NaH₂PO₄H₂O, 0.31 g NH₄Cl, 0.13 g KCl), 12.5 mL mineral and 5 mL vitamin solutions. The saline material compartment contained 5 g/L or 20 g/L NaCl in distilled water. The cathode compartment contained 50 mM PBS buffer. All solutions were replaced when the voltage decreased to <40 mV, forming a complete cycle of operation. MFDCs were operated at ambient temperatures (23±3° C.).

Analyses.

The voltage (E) across an external resistor (1000Ω, except as noted) in the MFDC was monitored at 20 minutes intervals using a multimeter (Keithley Instruments, OH) connected to a personal computer. Current (I), power (P=IE), and Coulombic efficiency (CE) were calculated as described in B. E. Logan et al, Environ. Sci. Technol., 2006, 40, 5181-5192, with the power density normalized by the projected area of the anode. Polarization curves were obtained by measuring the stable voltage generated at various external resistances ranging between 1000Ω and 50Ω (>15 minutes per resistor).

Phosphate was measured using the total phosphate method (HACH Company, Loveland, Colo.). Sodium and chloride ion concentrations were measured using combination electrodes and a meter (SympHony SB90M5, VWR International). Solution pH was monitored using a pH probe and meter (SympHony SB70P, VWR International). Electrolyte solution conductivities per cm were measured using a conductivity electrode (2 Cell Epoxy; SympHony SB90M5 meter; VWR International). All measurements were performed at the beginning and end of each fed-batch cycle. COD was measured according to standard methods described in APHPA, Standard Methods For The Examination Of Water And Wastewater, American Public Health Association Washington, D.C., 1992. Acetone, fatty acids (acetate, propionate, butyrate) and alcohols (methanol, ethanol, n-propanol and n-butanol) were analyzed using a gas chromatograph (Agilent, 6890) equipped with a flame ionization detector and a fused silica capillary column (Agilent, DB-FFAP) with helium as carrier gas as described in H. Liu et al, Environ. Sci. Technol., 2004, 38, 4040-4046.

Electromotive Force.

The electromotive force (E_{EMF}), generated by the diffusion of sodium and chloride ions across the membranes, is the sum of the potentials generated by the diffusion of Na⁺ across the AEM (E_{AEM}) and Cl⁻ across the CEM (E_{CEM}), or E_{EMF}=E_{AEM}+E_{CEM}. E_{AEM} produced by the diffusion of Cl⁻ ions from the saline material compartment to the anode compartment is given by:

$${E}_{AEM} = {α}_{AEM} \frac{RT}{zF} ln \frac{{a}_{c}^{+}}{{a}_{d}^{+}} \qquad ( 1 )$$

E_{CEM} engendered by the diffusion of Na⁺ ions from the saline material compartment to the cathodic compartment is given by:

$${E}_{CEM} = {α}_{CEM} \frac{RT}{zF} ln \frac{{a}_{c}^{+}}{{a}_{d}^{+}} \qquad ( 2 )$$

where α_{AEM} and α_{CEM} are the permselectivities of the AEM and CEM respectively, z the ion valence, R the gas constant, F Faraday's constant, and α_{c}⁺ and α_{d}⁺ the activities of the ions (Na⁺ or Cl⁻) in the concentrated and diluted compartments¹³ computed from their respective concentrations since the activity coefficients were close to 1 [range of 0.97 (diluted) to 0.92 (concentrated)].

The permselectivity of a membrane reflects its ability to selectively allow the passage of one species while restricting the passage of other species. When an ion exchange membrane is in contact with an electrolyte (salt solution), ions with the same charge (co-ions) as the fixed ions cannot enter the membrane by Donnan exclusion and should not pass through the membrane, while the oppositely charged free ions (counter ions) can pass freely through the membrane. The membrane permselectivity can be calculated as the ratio of the measured (ΔVₘ) to theoretical membrane potential (ΔVₜₕ) in a concentration cell as:

$$a ( \% ) = \frac{Δ {V}_{m}}{Δ {V}_{th}} \times 100 \qquad ( 3 )$$

The ΔVₘ across a membrane (7 cm²) separating two 4 cm cubic reactor compartments was measured using the static membrane potential measurements method of Dlugolecki et al, J. Membrane Sci., 2008, 319, 214-222. One cell was filled with 0.1 M NaCl, and the other with 0.5 M NaCl. The potential difference was measured using Ag/AgCl reference electrodes placed on either side of the membrane after steady conditions (30 minutes) at 25° C. The theoretical potential was calculated using the Nernst equation as;

$$Δ {V}_{th} = \frac{RT}{zF} ln \frac{{a}_{c}}{{a}_{d}} \qquad ( 4 )$$

MFDC performance with different substrate concentrations

Table I shows a summary of the conditions, extent of desalination in the desalination compartment (DC) and CE over multiple cycles, and maximum power and current densities from polarization curves.

The MFDCs acclimated to different substrate concentrations (1 or 2 g/L acetate) produced stable and equivalent maximum voltages three fed-batch cycles after inoculation with a fixed resistance (1000Ω), and 5 g/L of NaCl in the saline material compartment. With 1 g/L of acetate, the conductivity of NaCl water decreased by 43±6% and the CE over the cycle was 68±11% as shown in Table I.

TABLE I

| Acetate | NaCl | | | Desalination compartment (% | | | | |
|---|---|---|---|---|---|---|---|---|
| (g/L) | (g/L) | | | decrease) | | | Pₘₐₓ | Iₘₐₓ |
| [mM] | [mM] | Membrane | CE (%) | Conductivity | Na⁺ | Cl⁻ | (mW/m²) | (A/m²) |
| 1 [12] | 5 [85] | PS | 68 ± 11 | 43 ± 6 | 50 ± 1 | 61 ± 12 | 424 ± 57 | 2.80 ± 0.1 |
| 2 [24] | 5 [85] | PS | 66 ± 11 | 60 ± 7 | 57 ± 8 | 67 ± 0 | 159 ± 34 | 0.84 ± 0.2 |
| 2 [24] | 20 [342] | PS | 57 ± 22 | 50 ± 7 | 57 ± 9 | 43 ± 10 | 198 ± 36 | 0.90 ± 0.1 |
| 2 [24] | 20 [342] | PFS | 53 ± 5 | 63 ± 2 | 60 ± 6 | 53 ± 8 | 295 ± 27 | 0.81 ± 0.1 |

The data in Table I also show that increasing the acetate concentration to 2 g/L acetate increased the time of the cycle and improved the reduction in conductivity of the saline material compartment to 60%, but it did not substantially alter the CE (66±11%).

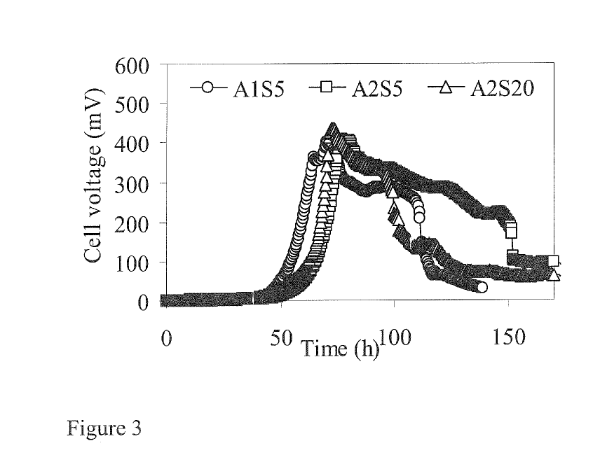

FIG. 3 is a graph showing MFDC performance as a function of initial substrate concentration and NaCl concentration. In FIG. 3 A=Acetate concentration in the anode compartment; S=NaCl concentration in the saline material compartment; and numbers indicate concentrations in g/L.

FIG. 3 shows that the use of a higher substrate concentration reduced maximum power densities, although the cycle time was increased.

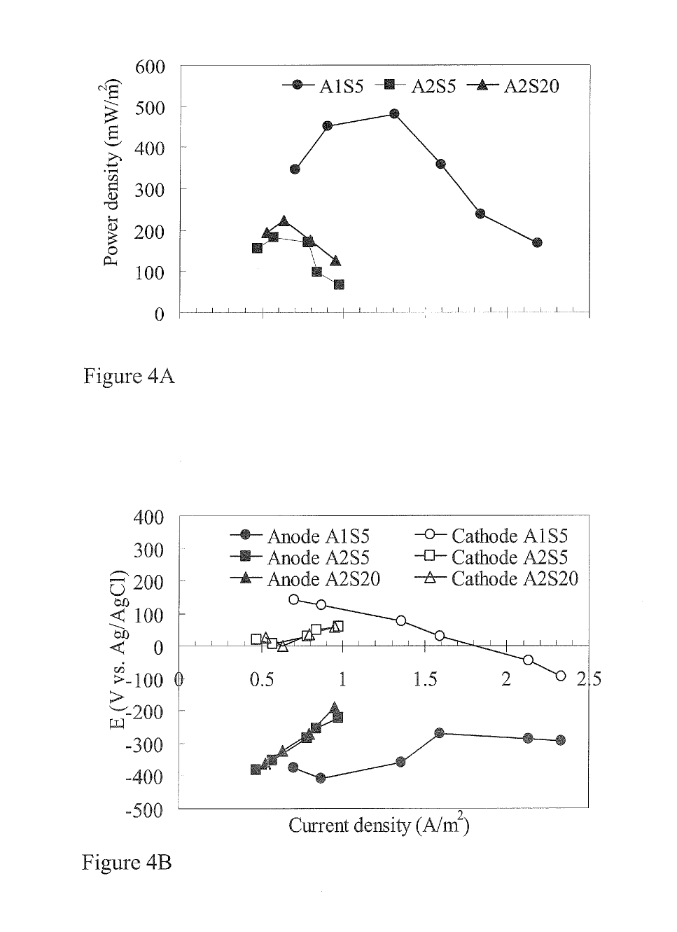

FIG. 4A is a graph showing polarization curves and FIG. 4B is a graph showing electrode potentials. In both FIGS. 4A and 4B, A=Acetate concentration in the anode compartment; S=NaCl concentration in the saline material compartment; and numbers indicate concentrations in g/L. Based on polarization data, 424±57 mW/m² was produced with 1 g/L of acetate compared to 159±34 mW/m² with 2 g/L of acetate.

The current densities with 1 g/L acetate reached 2.80±0.1 A/m², compared to <1 A/m² with 2 g/L of acetate. Measurement of the electrode potentials showed the largest change for the anode potential, suggesting that the higher acetate concentration inhibited the anode performance. However, separate tests with single-compartment MFDCs (2 cm cube reactor) did not show significant differences in power for reactors with 1 or 2 g/L of acetate. This result suggests that the reduced performance of the anode was due to other factors, such as poorer growth or biofilm inhibition due to the higher chloride concentrations with a greater extent of desalination, or low pH within the anode biofilm. The cathode performance was also slightly altered, although much of the difference is likely due to the reduced current density at the higher acetate concentration. The internal resistance with 1 g/L acetate (449±0.7% Ω), calculated from the slope of the polarization data, was about half that obtained with 2 g/L acetate (809±0.6% Ω) and was not affected by initial NaCl concentration.

Control experiments were performed under the same conditions, but without bacteria, to determine changes that would result from differences in osmotic pressure across the membranes during the same period of time as the biotic experiments. Conductivities of the controls decreased by 18±2% with 1 g/L of acetate and by 31±5% with 2 g/L acetate, during the same period as for a complete cycle in the presence of bacteria. The higher concentration of acetate (2 g/L) reduced the difference in osmotic pressure, producing a lower decrease in conductivity in the desalination cell (15±1%).

The three compartments were tested for acetate and phosphate at the end of every cycle. All acetate was completely consumed and did not accumulate in any other compartments. Phosphate ions were not found to have migrated into the middle saline material compartment.

Changes in conductivity and pH in the electrode compartments.

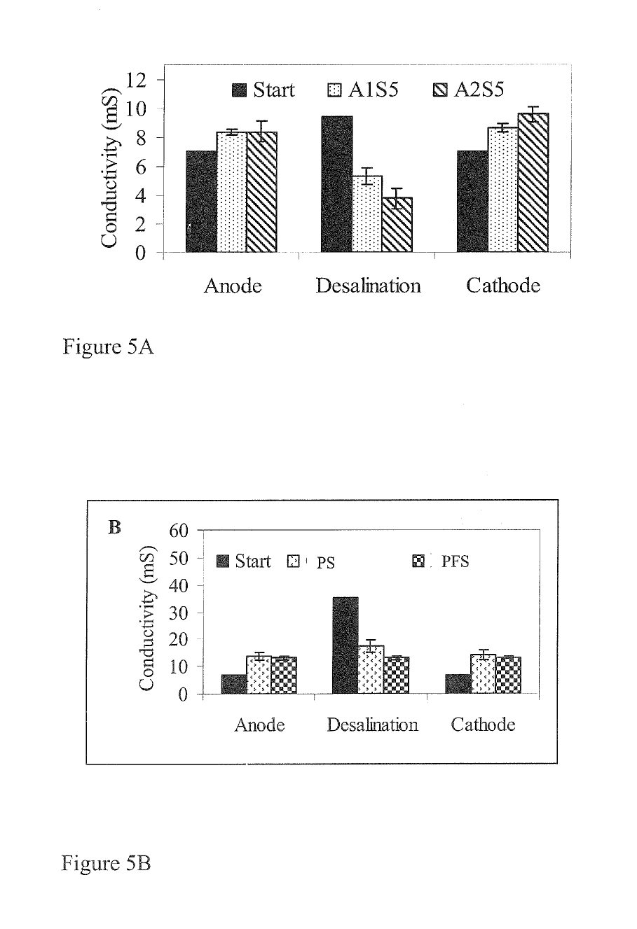

FIG. 5A is a graph showing conductivities in MFDC compartments for PS membranes with different anode and saline material compartment concentrations of acetate and NaCl, A=Acetate concentration in the anode compartment; S=NaCl concentration in the saline material compartment; and numbers indicate concentrations in g/L. FIG. 5B is a graph showing performance of PS and PFS membranes with 2 g/L acetate (anode) and 20 g/L NaCl (saline material compartment).

Conductivity changes in the anode and cathode compartments were much less than those in the saline material compartment. For example, the anode compartment conductivity increased by only 16% when the conductivity of the saline material compartment decreased by 60% (5 g/L NaCl saline material compartment, 2 g/L acetate anode compartment). The reason for this smaller conductivity change is primarily due to changes in the predominant chemical species of the buffer. In a single cycle with 2 g/L acetate and 5 g/L NaCl in the saline material compartment, chloride ions increased from 0.4 g/L to 2 g/L in the anode compartment. Over the same cycle, the anode compartment pH decreased from 7.2 to 6.2±0.2. At neutral pH, the buffer is primarily an equal mixture of HPO₄²⁻ and H₂PO₄⁻. However, as the bacteria release protons into solution the pH decreases, resulting in protonation of the buffer and reduced solution conductivity. When 1 g/L of acetate was used, the final anode compartment pH was 6.2±0.2. Under these conditions, the concentration of H₂PO₄⁻ was 46 mM, compared to only 4.2 mM of HPO₄²⁻. Larger changes in pH occurred with 2 g/L of acetate, with a final pH in the anode compartment of 4.5±0.8, shifting the predominant phosphate species further to the protonated form (H₂PO₄⁻, 50 mM; H₃PO₄, 0.20 mM; HPO₄²⁻, 0.11 mM). The resulting impact of both chloride addition to the anode compartment and the decrease in pH was therefore only a modest increase in anode compartment conductivity.

Effect of Higher NaCl Concentration.

When 20 g/L of NaCl was placed in the saline material compartment (2 g/L acetate in the anode compartment), the initial maximum voltage was similar to that achieved with 5 g/L of NaCl, but the voltage dropped off more rapidly likely as a result of the greater influx of chloride into the anode compartment. Even though the initial NaCl concentration was larger by a factor of four, the total desalination was reduced by only 17% to an overall 50% decrease in solution conductivity over the cycle. Maximum power, electrode potentials, and CE were similar to that obtained with 5 g/L of NaCl at this initial acetate concentration.

Effect of the Membranes on Desalination and System Performance.

Water desalination and power densities were both improved through the use of the PFS membranes that were thinner and had higher IECs than the PS membranes. The conductivity of the NaCl solution in the saline material compartment decreased by 63%, which is a 26% increase in desalination compared to tests under the same conditions with PS membranes (2 g/L acetate, and 20 g/L NaCl). Power increased to 295±27 mW/m² and the CE of 53±5% was similar to that obtained with the PS membranes.

Membrane Electromotive Force.

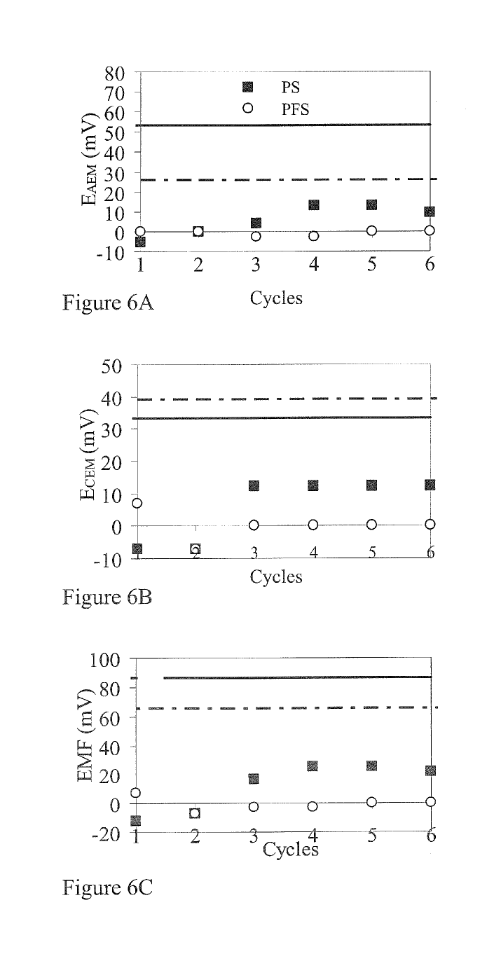

FIG. 6A is a graph showing membrane potentials generated by ion concentration gradients across the AEM, from the saline material compartment towards the anode compartment. FIG. 6B is a graph showing membrane potentials generated by ion concentration gradients across the CEM, from the saline material compartment to the cathode compartment. FIG. 6C is a graph showing the generated electromotive force (EMF). The lines in FIGS. 6A, 6B and 6C indicate potentials at the beginning of each cycle for commercial (solid lines) and experimental (dashed) membranes.

The magnitude of the membrane electromotive force over successive cycles with the two different membranes provides insight into the extent of charge transfer relative to equilibrium. The potentials at the beginning of each cycle relative to movement of ions from the saline material compartment into the electrode compartments were both highly positive, resulting in an overall positive E_{EMF}. The commercial AEM initially (time 0) had a higher E_{AEM} than the experimental AEM because the permselectivity coefficient of the commercial AEM was twice as large. The experimental CEM initially had a higher E_{CEM} than the commercial CEM since its permselectivity coefficient was 5% greater. The average permselectivities of the commercial membranes were α_{AEM}=94% and α_{CEM}=90%. For the experimental membranes, they were α_{AEM}=44% and α_{CEM}=95%. The α_{AEM} of the experimental membrane was low because it had a high water uptake (70%) compared to the commercial AEM (21%) or CEM (26%, commercial; 29% experimental).

The best desalination performances are usually obtained when the E_{EMF} is negative indicating that the ionic concentration in the saline material compartment was driven past equilibrium by the current and potential generated by the MFDC and that the saline material compartment has lower ionic concentrations than the anode or cathode compartments. The lowest EMF values were obtained at the end of the first two cycles. The good performance of the first two cycles was due to the fact that the first cycles were longer so that the MFDC remained at its maximum cell voltage for a longer period of time with greater desalination. After the third cycle, the MFDC cell voltage decreased more rapidly and thus less current was available to drive the ions from the saline material compartment to the side compartments. At the end of each cycle, the AEM and CEM potentials for the experimental membranes were always close to zero while the potentials of the commercial membranes remained positive. The E_{EMF} values at the end of each cycle remained higher for the commercial membrane as expected, because fewer ions were transported through these membranes as compared to the experimental membranes.

In this example, a single cycle of operation using an 1 g/L acetate solution reduced the conductivity of salt water (5 g/L NaCl) by 43±6%, and produced a maximum power density of 480 mW/m² with a Coulombic efficiency of 68±11%. A higher concentration of acetate (2 g/L) reduced solution conductivity by 60±7%, and a higher salt concentration (20 g/L NaCl) reduced solution conductivity by 50±7%. The use of membranes with increased ion exchange capacities further decreased the solution conductivity by 63±2% (20 g/L NaCl).

Microbial Electrodialysis Desalination Cell (MEDC)

A three compartment reactor configured as an MEDC was constructed which includes an anode compartment containing a flat carbon cloth anode with bacteria growing on the anode, a cathode compartment containing a carbon cloth cathode coated with platinum catalyst on one side (facing the anode compartment), and a saline material compartment between the anode and cathode compartments containing a salt water solution with 5 or 20 g/L of NaCl. An anion exchange membrane separates the saline material compartment and the anode. A cation exchange membrane separates the cathode and the saline material compartment. The reactor is operated by applying a voltage of 0.45 or 0.65 V, while 0.9 V did not operate well in this system (likely due to anode potentials created that were not favorable to the bacteria on the anode). This system was stable in performance in MEDC mode if the reactor was first operated as an MFDC with three compartments for 15 days, but not when the anode was started up in a MFC (single compartment) likely due to adverse effects of chloride on the bacteria. Thus, acclimation of the bacteria on the anode is important for start up of this system.

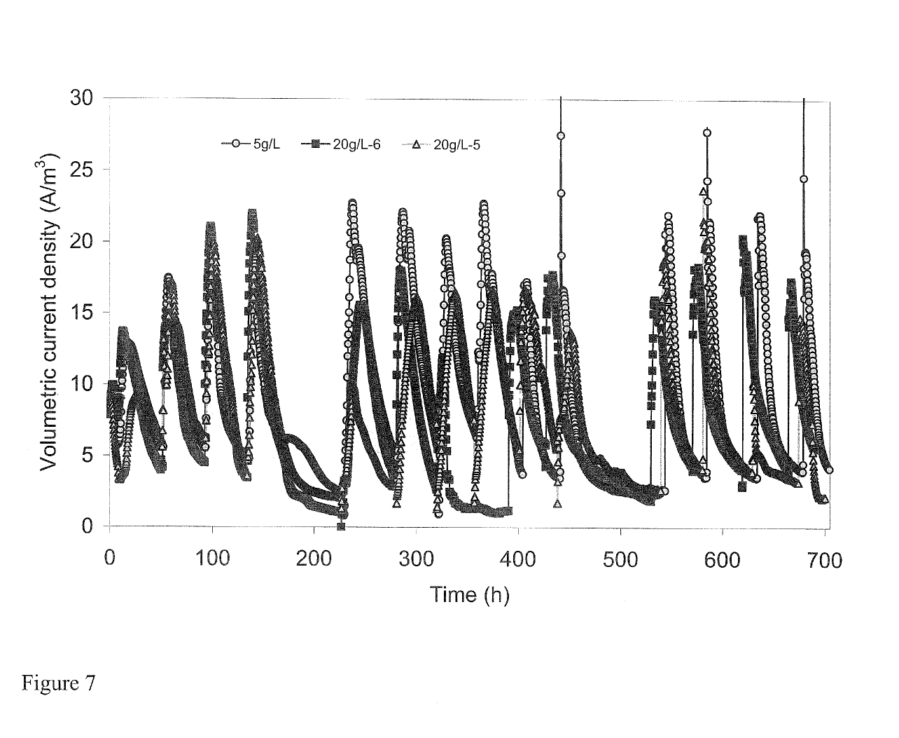

FIG. 7 is a graph showing volumetric current densities as a function of time. Under these conditions, maximum current densities were in the range of 20 to 25 A/m³.

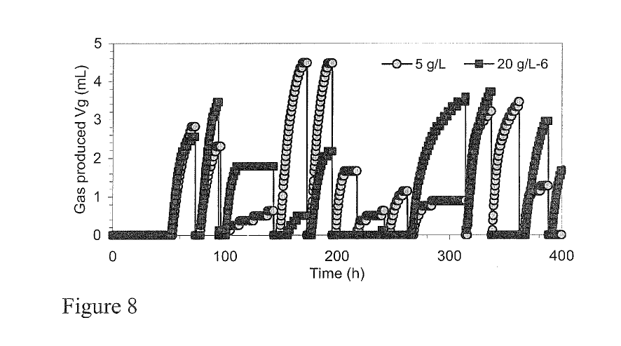

FIG. 8 is a graph showing gas production as a function of time. Hydrogen recoveries were low due to leaks in the system around the membranes.

The microbial community in the system was analyzed and the analysis showed that the MEDC including 5 g/L of NaCl in the saline material compartment was dominated by Pelobacter propionicus (58% of 59 clones) and Geobacter sulfurreducens (14%) while the reactor including 20 g/L of NaCl in the saline material compartment was dominated more by G. sulfurreducens (30% of 73 clones) and P. propionicus (23%).

Any patents or publications mentioned in this specification are incorporated herein by reference to the same extent as if each individual publication is specifically and individually indicated to be incorporated by reference.

The compositions and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. A desalination process, comprising:
providing a system for desalination, comprising a reaction chamber having a wall defining an interior of the reaction chamber and an exterior of the reaction chamber; an anode at least partially contained within an anode compartment of the reaction chamber; a plurality of anodophilic bacteria disposed in the anode compartment; a cathode at least partially contained within a cathode compartment of the reaction chamber; a conductive conduit for electrons in electrical communication with the anode and the cathode; a saline material compartment disposed between the anode compartment and the cathode compartment; a first anion selective barrier disposed between the saline material compartment and the anode compartment such that anions moving from the saline material compartment traverse the first anion selective barrier to a compartment adjacent an anion selective barrier and cations are substantially prevented from moving from the saline material compartment to the compartment adjacent an anion selective barrier; and a first cation selective barrier disposed between the saline material compartment and the cathode compartment to a compartment adjacent a cation selective barrier such that cations moving from the saline material compartment traverse the first cation selective barrier and anions are substantially prevented from moving from the saline material compartment to the compartment adjacent a cation selective barrier;
introducing a material oxidizable by an oxidizing activity of the anodophilic bacteria;
incubating the material oxidizable by the anodophilic bacteria under oxidizing reactions conditions such that electrons are produced and transferred to the anode, generating a potential between the anode and cathode; and
introducing a saline material into the saline material compartment.

2. The process of claim 1, further comprising activating a power source in electrical communication with the anode and cathode to increase a potential between the anode and the cathode.

3. The process of claim 1, wherein the system further comprises at least a second anion selective barrier.

4. The process of claim 1, wherein the system further comprises at least a second cation selective barrier.

5. The process of claim 1, wherein the first anion selective barrier is an anion exchange membrane.

6. The process of claim 1, wherein the first cation selective barrier is a cation exchange membrane.

7. The process of claim 1, wherein the material oxidizable by an oxidizing activity of the anodophilic bacteria is wastewater.

8. The process of claim 7, wherein the wastewater has a conductivity lower than the conductivity of the saline material.

9. The process of claim 2, wherein the system further comprises a gas collection system.

10. The process of claim 2, wherein the power source is at least partially powered by the hydrogen and/or methane gas produced.

11. The process of claim 1, wherein the cathode is an air cathode.

12. The process of claim 8, wherein saline water is added to the wastewater to increase conductivity of the wastewater prior to introduction of the wastewater into the anode compartment.

13. The process of claim 1, wherein the anode and/or cathode is a brush electrode.

14. The process of claim 1, wherein the anode and/or cathode is a tubular electrode.

15. The process of claim 2, wherein the power source comprises setting the anode potential.

16. A system for desalination, comprising:
a reaction compartment having a wall defining an interior of the reaction compartment and an exterior of the reaction compartment;
an anode at least partially contained within an anode compartment of the reaction compartment;
a plurality of anodophilic bacteria disposed in the anode compartment;
a cathode at least partially contained within a cathode compartment of the reaction compartment;
a conductive conduit for electrons in electrical communication with the anode and the cathode;
a saline material compartment disposed between the anode and the cathode;
an anion exchange material disposed between the saline material compartment and the anode such that anions moving from the saline material compartment traverse the anion exchange material; and
a cation exchange material disposed between the saline material compartment and the cathode such that cations moving from the saline material compartment traverse the cation exchange material.

17. The system of claim 16, further comprising a gas collection system.

18. The system of claim 16, further comprising a reference electrode.

19. The system of claim 16, further comprising activating a power source in electrical communication with the anode and cathode to increase a potential between the anode and the cathode, such that electrons and protons combine to produce hydrogen and/or methane gas.

20. The system of claim 16, wherein the system further comprises at least a second anion selective barrier.

21. The system of claim 16, wherein the system further comprises at least a second cation selective barrier.

22. The system of claim 16, wherein the first anion selective barrier is an anion exchange membrane.

23. The system of claim 16, wherein the first cation selective barrier is a cation exchange membrane.

24. The system of claim 16, wherein the cathode is an air cathode.

25. The system of claim 16, wherein the anode and/or cathode is a brush electrode.

26. The system of claim 16, wherein the anode and/or cathode is a tubular electrode.

27. A desalination process, comprising:
generating an electrical potential between an anode and a cathode, wherein at least a portion of the electrical potential is generated by anodophilic bacteria disposed in electrical contact with the anode; and
positioning a saline material between the anode and the cathode, the saline material separated from the anode by an anion exchange material and separated from the cathode by a cation exchange material.

28. A desalination process, comprising:
providing a system for desalination, comprising a reaction chamber having a wall defining an interior of the reaction chamber and an exterior of the reaction chamber; an anode at least partially contained within an anode compartment of the reaction chamber; a plurality of anodophilic bacteria disposed in the anode compartment; a cathode at least partially contained within a cathode compartment of the reaction chamber; a conductive conduit for electrons in electrical communication with the anode and the cathode; a saline material compartment disposed between the anode and the cathode; a first anion selective barrier disposed between the saline material compartment and the anode such that anions moving from the saline material compartment traverse the first anion selective barrier; and a first cation selective barrier disposed between the saline material compartment and the cathode such that cations moving from the saline material compartment traverse the first cation selective barrier;
introducing a material oxidizable by an oxidizing activity of the anodophilic bacteria;
incubating the material oxidizable by the anodophilic bacteria under oxidizing reactions conditions such that electrons are produced and transferred to the anode, generating a potential between the anode and cathode;
introducing a saline material into the saline material compartment;
activating a power source in electrical communication with the anode and cathode to increase a potential between the anode and the cathode, such that electrons and protons combine to produce hydrogen and/or methane gas; and
fueling the power source with the produced hydrogen and/or methane gas.
